(19) United States
(12) Patent Application Publication
(10) Pub. No.: US 2026/0320464 A1
(43) Pub. Date: Oct. 15, 2026

(54) QUANTUM-CLASSICAL DECOMPOSITION OF THE UNIT COMMITMENT PROBLEM

(71) Applicant: IonQ, Inc., College Park, MD (US)

(72) Inventor: Guillermo Antonio ABOUMRAD, Hollywood, FL (US)

(21) Appl. No.: 19/647,304

(22) Filed: Apr. 14, 2026

Related U.S. Application Data
(60) Provisional application No. 63/788,631, filed on Apr. 14, 2025.

(51) Int. Cl. G06N 10/60; G06N 10/20; G06Q 10/04; G06Q 30/0283; G06Q 50/06

(52) U.S. Cl. CPC G06N 10/60; G06N 10/20; G06Q 10/04; G06Q 30/0283; G06Q 50/06

(57) ABSTRACT

A system and method are provided for solving a mixed-integer optimization program having both binary and continuous variables in a power system. An exemplary method includes: obtaining a formulation of the mixed-integer program (MIP) comprising a set of binary decision variables representing on and off activation states for generation units, and a set of continuous decision variables representing operational levels associated with the generation units; determining a subset of candidate binary variable assignments by applying a quantum approach; for each candidate binary assignment, solving a continuous-variable subproblem on a classical processor to determine corresponding values for continuous decision variables that minimize an objective cost subject to one or more constraints using a classical optimization routine; evaluating a total cost for each combination of binary assignments and corresponding continuous-variable solution; and selecting a combination of binary and continuous decision variable values that yields a solution to the MIP.

### CROSS REFERENCE TO RELATED APPLICATIONS

The current application claims priority to U.S. Patent Provisional Application No. 63/788,631, filed Apr. 14, 2025, the entire contents of which are hereby incorporated by reference.

### TECHNICAL FIELD

Aspects of the present disclosure relate generally to systems and methods for use in the implementation and/or operation of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

The present disclosure describes various aspects of systems and methods for solving the Unit Commitment (UC) problem. Solving large-scale power system planning and operational problems on classical computers presents significant challenges due to the complexity, scalability, and mixed-integer nonlinear nature of these problems. Quantum computing offers a promising alternative due to its potential to deliver computational advantages over classical methods. The present disclosure describes a hybrid quantum-classical algorithm for solving the UC problem, which seeks to minimize the total cost of electricity generation by determining optimal unit activation and power dispatch to meet hourly load demands. The present disclosure employs a Bender's-type heuristic comprising three stages: (1) generation of candidate unit commitment vectors using a quantum algorithm, where each vector represents a feasible on/off configuration of generating units with low estimated operating cost; (2) refinement of these candidates using a classical optimizer to determine optimal power dispatch levels; and (3) selection of the combined unit commitment and power dispatch solution yielding the lowest total cost.

In some aspects, the techniques described herein relate to a method for controlling operation of a power system. The method includes: obtaining, by a classical processor, a formulation of the mixed-integer program (MIP) comprising a set of binary decision variables representing on and off activation states for generation units, and a set of continuous decision variables representing operational levels associated with the generation units; determining, by a quantum processing unit (QPU), a subset of candidate binary variable assignments by executing a parameterized quantum circuit that encodes a cost metric associated with the binary decision variables, wherein the candidate binary variable assignments are generated based on measurement outcomes of qubit states of the quantum circuit; for each candidate binary assignment, solving, by the classical processor using a constrained numerical optimization routine, a continuous-variable subproblem to determine corresponding values for the continuous decision variables that minimize an objective cost subject to one or more physical operating constraints of the power system; evaluating, by the classical processor, a total cost for each combination of the candidate binary assignments and corresponding continuous-variable solution, wherein the total cost corresponds to an aggregate operating cost associated with a specific combination of binary and continuous decision variables; selecting, by the classical processor, a combination of binary and continuous decision variable values that yields a solution to the MIP; and outputting control signals for at least one generation unit based on the selected combination of binary and continuous decision variable values to control operation of the power system.

In some aspects, the techniques described herein relate to a hybrid quantum-classical optimization system for controlling operation of a power system. The system including: a classical computing system comprising one or more processors and memory storing instructions that, when executed, cause the classical computing system to: obtain a formulation of a mixed-integer optimization program (MIP) comprising: (i) a set of binary decision variables representing on and off activation states for generation units, and (ii) a set of continuous decision variables representing operational levels associated with the generation units; for each candidate binary variable assignment, solve a continuous-variable subproblem using an optimization routine to determine corresponding values for the continuous decision variables that minimize an objective cost subject to one or more physical operating constraints of the power system; evaluate a total cost for each combination of candidate binary variable assignments and corresponding continuous-variable solutions; and select a combination of binary and continuous decision variable values based on the evaluated total cost; and a quantum processing unit (QPU) communicatively coupled to the classical computing system and configured to: receive data representing at least the binary decision variables and an associated cost metric of the MIP; encode the binary decision variables and the associated cost metric into a parameterized quantum circuit; execute the parameterized quantum circuit using a sequence of quantum gate operations; and generate a subset of candidate binary variable assignments based on measurement outcomes of qubit states resulting from execution of the parameterized quantum circuit; an interface configured to transmit the subset of candidate binary variable assignments from the QPU to the classical computing system; and a control module configured to generate control signals for at least one generation unit of the power system based on the selected combination of binary and continuous decision variable values to control operation of the power system, wherein the hybrid quantum-classical optimization system is configured to reduce computational complexity of solving the mixed-integer optimization program relative to a classical-only optimization system.

In some aspects, the techniques described herein relate to a non-transitory computer-readable storage medium storing computer-readable instructions thereon, which, when executed by processing circuitry, cause the processing circuitry to perform a method for controlling operation of a power system. The method includes: obtaining, by a classical processor, a formulation of the mixed-integer program (MIP) comprising a set of binary decision variables representing on and off activation states for generation units, and a set of continuous decision variables representing operational levels associated with the generation units; determining, by a quantum processing unit (QPU), a subset of candidate binary variable assignments by executing a parameterized quantum circuit that encodes a cost metric associated with the binary decision variables, wherein the candidate binary variable assignments are generated based on measurement outcomes of qubit states of the quantum circuit; for each candidate binary assignment, solving, by the classical processor using a constrained numerical optimization routine, a continuous-variable subproblem to determine corresponding values for the continuous decision variables that minimize an objective cost subject to one or more physical operating constraints of the power system; evaluating, by the classical processor, a total cost for each combination of the candidate binary assignments and corresponding continuous-variable solution, wherein the total cost corresponds to an aggregate operating cost associated with a specific combination of binary and continuous decision variables; selecting, by the classical processor, a combination of binary and continuous decision variable values that yields a solution to the MIP; and outputting control signals for at least one generation unit based on the selected combination of binary and continuous decision variable values to control operation of the power system.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions in a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates a diagram of an example of the Unit Commitment (UC) problem in accordance with aspects of this disclosure.

FIG. 5 illustrates a method for solving a mixed-integer program (MIP) having both binary and continuous variables for each generating unit in a power system in accordance with aspects of this disclosure.

FIG. 6 illustrates an example of a QIP system in accordance with aspects of this disclosure.

Like reference numbers and designations in the various drawings indicate like elements.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

Solving large-scale power system problems related to planning and operations on classical computers poses significant challenges due to issues of scalability and the inherently complex nature of these problems, which often involve mixed-integer and nonlinear formulations. Quantum computing, as an emerging computational paradigm, offers promising advantages for addressing such challenges, particularly due to its potential for quantum speedup over classical approaches.

The present disclosure describes a hybrid quantum-classical algorithm based on a quantum algorithm for solving a Unit Commitment (UC) problem in power systems. The UC problem is a fundamental optimization task in power systems, wherein the objective is to minimize total generation cost while determining the optimal on/off status of generating units and their corresponding power outputs to satisfy hourly load demands. Specifically, each generation unit is associated with a binary decision variable indicating whether the unit is active (on) or inactive (off), and a continuous decision variable representing the power output level when the unit is online. As used herein, “generation units” refers to power-producing equipment within a power system, such as power plants, generators, or other electricity-generating facilities, each of which is associated with operational characteristics including minimum and maximum power output bounds, cost functions, and commitment costs.

The problem is formally expressed as a Mixed Integer Program (MIP), which includes objective terms corresponding to fuel costs, startup and shutdown costs, and potentially other penalties or incentives, along with constraints such as minimum up/down time, generation capacity bounds, ramping limits, and overall power balance. Due to the exponential growth of the solution space with respect to the number of binary variables, the UC problem is at least non-deterministic polynomial-time (NP)-hard to solve, and classical solvers are generally limited to solving instances involving no more than approximately 1,000 generating units (e.g., binary variables) in practice.

In many power system optimization tasks, the underlying mathematical formulation is a MIP, which includes both discrete and continuous decision variables. As used herein, a MIP refers to an optimization problem comprising both binary decision variables and continuous decision variables, wherein the binary variables represent discrete on/off activation states and the continuous variables represent real-valued operational parameters, and wherein the combinatorial structure of the binary variable space renders the problem computationally intractable (at least NP-hard) for classical solvers at scale. In the context of unit commitment, the discrete variables represent on/off activation decisions for individual generation units—i.e., power-producing resources such as generators or power plants—while the continuous variables represent the corresponding power output levels of those units when active. This combined structure captures the operational reality of power systems, where generation units must be selectively committed and dispatched to meet demand at minimum cost.

To address these scalability limitations, conventional methods introduce a hybrid quantum-classical approach that decomposes the UC problem into a tractable sequence of subproblems using the Quantum Approximate Optimization Algorithm (QAOA). The core idea is to separate the optimization over continuous and binary variables through an alternating optimization framework. In each iteration, a classical optimizer proposes candidate values for the continuous variables, effectively determining fixed power output levels for the generating units assumed to be online. Once these real-valued parameters are fixed, the original MIP is reduced to a pure binary optimization problem, specifically a Quadratic Unconstrained Binary Optimization (QUBO) problem. This transformation is achieved by substituting the fixed continuous values into the original cost function and constraints, resulting in a cost function that depends solely on the binary decision variables.

The binary QUBO problem is then passed to a quantum subroutine based on QAOA. QAOA is a variational quantum algorithm that iteratively applies parameterized quantum gates to prepare quantum states encoding candidate binary solutions. The quantum circuit is executed multiple times to sample bit-strings, which are interpreted as possible configurations of unit commitment (i.e., which generators are turned on or off). The cost, or expected energy, of these sampled solutions is computed using the QUBO objective function and represents the quality of the binary solution given the current continuous variable setting. This cost value is then used as the objective feedback in the classical optimization loop, which updates the continuous variable settings accordingly. The process is repeated, with each cycle refining the candidate solution space, until a predefined stopping criterion is met-such as convergence of the cost function, satisfaction of constraints, or a maximum number of iterations. This hybrid approach effectively leverages the quantum subroutine to explore the combinatorial structure of the binary variable space, while relying on classical optimization techniques to handle the continuous dimensions of the UC problem. Since the QAOA is used as a subroutine, these conventional methods require executing many more quantum circuits than is feasible. Accordingly, the present disclosure enables solution of larger and more complex instances of the UC problem than are feasible with the conventional method described above, with potential applications in real-time power system operations.

As will be described in more detail below, the present disclosure begins by using a quantum device to identify a set of candidate unit commitment vectors—on/off configurations for generation units—that satisfy the power demand and are associated with low estimated minimum generation costs. Next, for each of these binary candidates, classical optimization routines are used to solve corresponding continuous-variable subproblems, determining the optimal power output levels for the committed units. Each of these subproblems yields a complete, feasible solution. Finally, the method evaluates the total generation cost for each candidate, selects the one with the lowest cost as the final solution, and outputs control signals to the generation units to implement the selected unit commitment schedule and dispatch levels, thereby controlling operation of the power system based on the optimized solution.

The present disclosure provides a hybrid quantum-classical algorithm for solving the UC problem in power systems, offering several technical advantages over traditional classical approaches. By decomposing the UC problem, which is formulated as a MIP, into a series of real-valued quadratic programs (QPs), the present disclosure enables scalable handling of problems involving both binary and continuous decision variables. For example, the present disclosure may leverage a variational quantum algorithm (VQA) to sample a subset of promising unit commitment vectors that minimize estimated lower-bound generation costs, thereby efficiently navigating the exponentially large solution space. Feasibility of candidate vectors is rapidly assessed using classical constraints, which filter out configurations incapable of meeting system demand, reducing unnecessary computation. For example, for each feasible candidate, the algorithm employs classical Sequential Least Squares Programming (SLSQP) to solve residual QPs and determine optimal power dispatch levels. This quantum-classical decomposition not only improves computational efficiency but also enables parallel execution of subproblems and modular integration of future improvements.

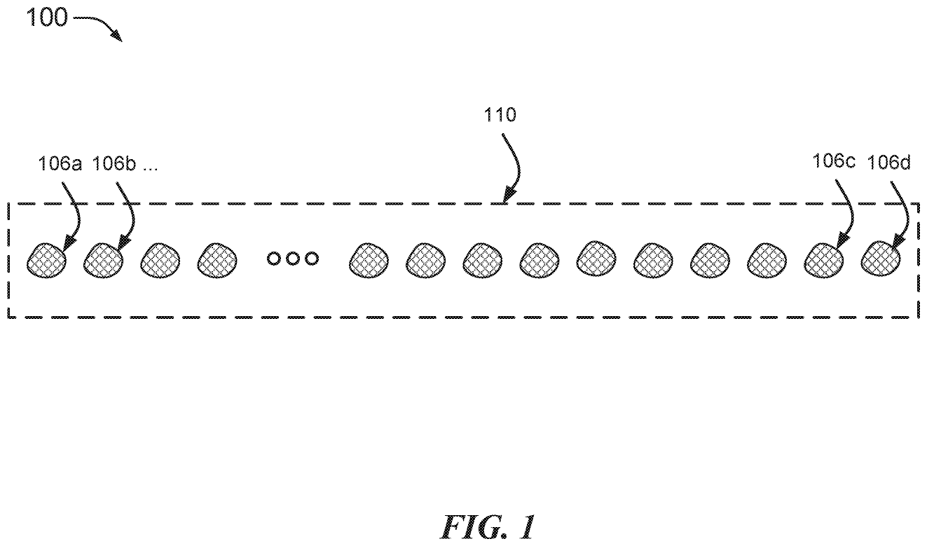

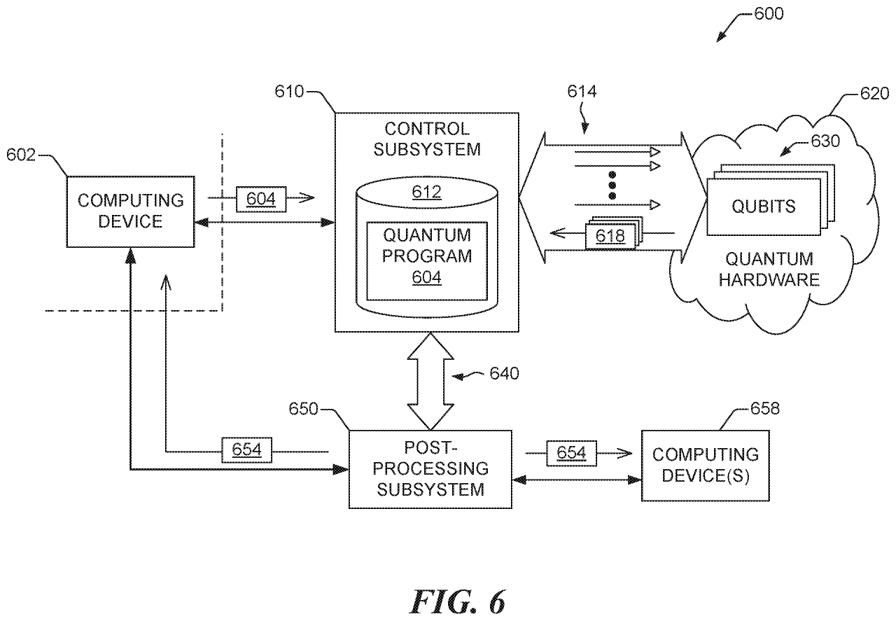

Solutions to the issues described above are explained in more detail in connection with FIGS. 1-6, with FIGS. 1-3 providing a general description of an exemplary QIP system or quantum computer, and more specifically, of atomic-based QIP systems or quantum computers, that can be configured to implement the systems and methods described herein. In addition, FIG. 6 illustrating a QIP system on which aspects of systems and methods for solving a mixed-integer optimization program having both binary and continuous variables in a power system according to aspects of the present disclosure.

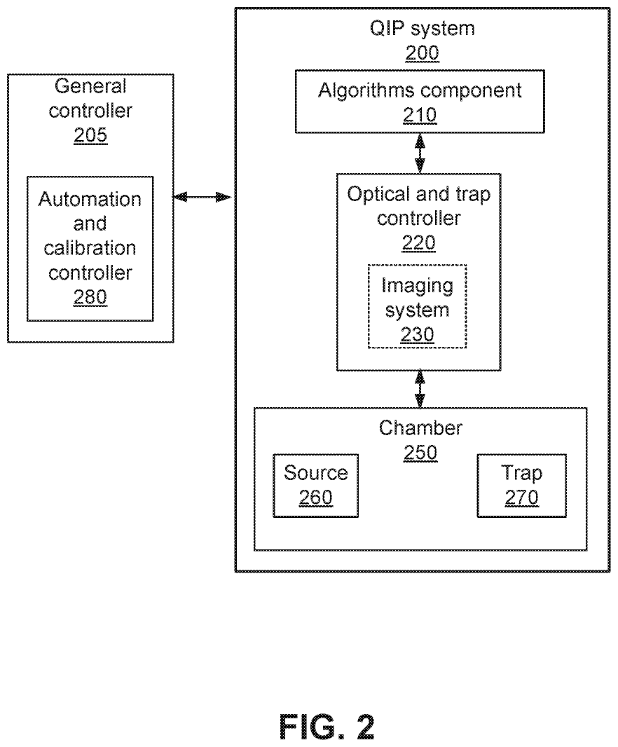

FIG. 1 illustrates a diagram 100 with multiple atomic ions or ions 106 (e.g., atomic ions 106a, 106b, . . . , 106c, and 106d) trapped in a linear crystal or chain 110 using a trap (the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple atomic ions (e.g., a plurality of ions) into the chain 110 that are laser-cooled to be nearly at rest. The number of atomic ions (N) trapped can be configurable and more or fewer atomic ions may be trapped. The atomic ions can be Ytterbium ions (e.g., 171Yb+ ions), for example. The atomic ions are illuminated with laser (optical) radiation tuned to a resonance in 171Yb+ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

As will be described in detail below, and according to an exemplary aspect, the ions in the ion trap can be configured by applying a laser (e.g., a Raman configuration) to one or more of the plurality of qubits to set a probability of a single event by rotating the one or more qubits to fix a relative angle of the at least one qubit. These details will be described below.

FIG. 2 is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200, including the methods and algorithms described herein. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. The algorithms component 210 may also include software tools (e.g., compilers) that facilitate such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems (e.g., optical sources) can be at least partially located in the optical and trap controller 220 and/or in the chamber 250. For example, optical systems within the chamber 250 may refer to optical components or optical assemblies. The optical and trap controller 220 can be configured to generate one or more lasers to rotate the ions and set a probability of the respective events associate with each qubit. For example, optical sources of the optical and trap controller 220 can be configured to ionization of the atomic species, control (e.g., phase control) of the atomic ions, and for fluorescence of the atomic ions that can be monitored and tracked by image processing algorithms operating in an imaging system 230, for example.

More particularly, the QIP system 200 can include an imaging system 230 that may comprise a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210. These and/or components of the QIP system 200 may be used in connection with the techniques for determining qubit placement in a quantum circuit.

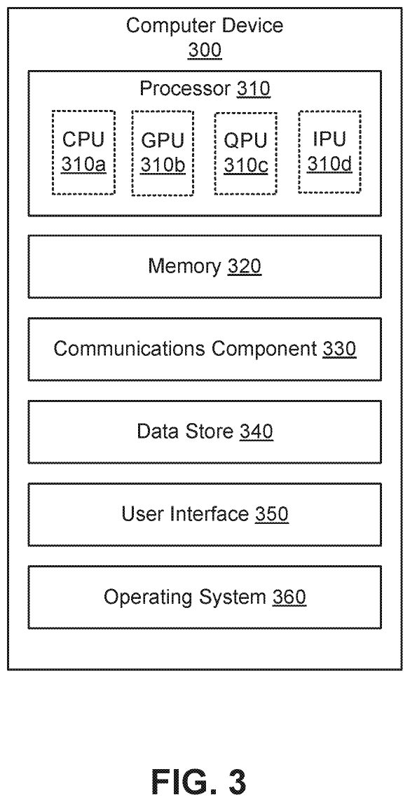

FIG. 3 illustrates an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

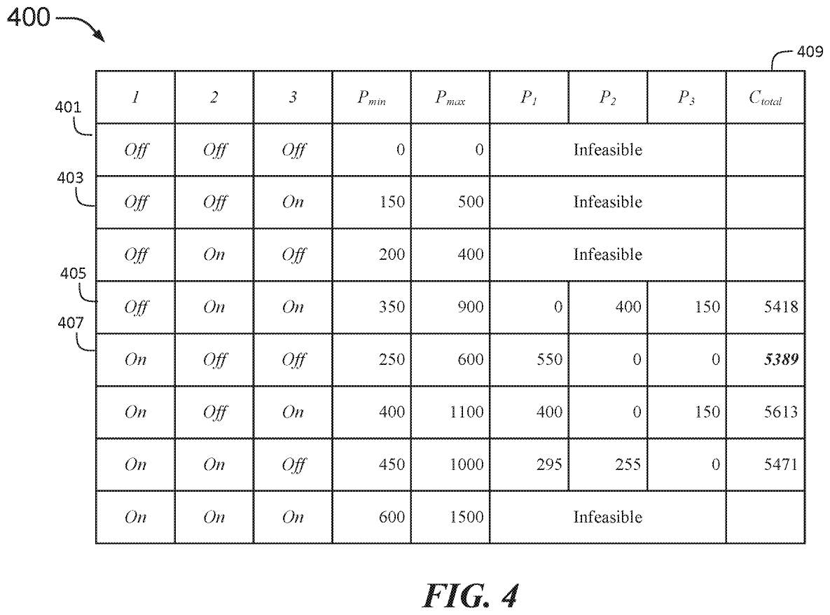

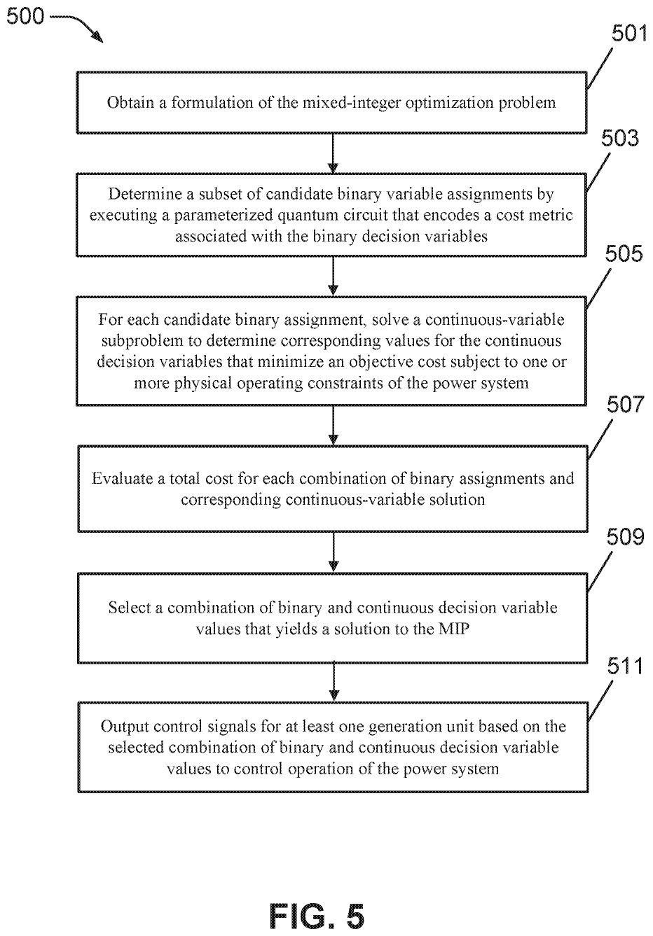

In connection with the systems described in FIGS. 1-3 and 6, and with further details provided in FIGS. 4-5, the present disclosure provides various aspects of techniques for solving a mixed-integer optimization program having both binary and continuous variables in a power system using a quantum-classical approach.

As will be described in more detail below, FIG. 4-5 expand upon the system architecture and operational systems described in FIGS. 2-3 by detailing the specific process of solving an MIP problem with a binary and a real variable for each generating unit. FIGS. 2 and 3 provide an overview of the QIP system and its computational architecture, including components like the general controller, quantum processors, and memory modules. FIGS. 4-5 build upon this by illustrating how these components interact to achieve a core system capable of solving the UC MIP problem using a hybrid quantum-classical approach. FIG. 6 describes a QIP system on which aspects of the present disclosure may be implemented. Together, these figures describe the system-level claims with detailed operational workflows, highlighting the ability to represent text in the qubits of quantum computers.

The present disclosure addresses the critical need within power grid management to minimize the total cost of electricity generation while ensuring that power supply reliability meets time-varying demand across all users connected to the grid. This operational objective is conventionally modeled by the UC problem, which is formulated as a MIP comprising binary and continuous decision variables. Each binary variable denotes the on/off status of a corresponding generation unit, while each continuous variable represents the power output level of an active unit. As used herein, “controlling operation of a power system” encompasses the end-to-end process of computationally determining an optimized unit commitment schedule and power dispatch plan and causing the resulting operational directives to be implemented by the generation units of the power system, whether through direct transmission of electronic control signals, through an intermediate dispatch controller or energy management system (EMS), or through presentation to a human grid operator who effectuates the determined schedule. Accordingly, the UC problem is not merely an abstract planning exercise; rather, its solution directly governs the physical activation states and power output levels of generation equipment in the power system.

The goal of the UC problem is to identify a cost-optimal configuration of unit statuses and power outputs that satisfies specified hourly demand constraints and that can be translated into actionable control directives for the generation units. Owing to the combinatorial structure and mixed-integer nature of the formulation, the UC problem is computationally intractable in general and is classified as at least NP-hard. Existing classical optimization solvers are limited in scalability and are typically capable of handling UC instances involving approximately 1,000 binary variables or fewer. As such, improvements in UC solution methodologies enhance computational efficiency, solution quality, and scalability. These benefits are particularly pronounced for large-scale utilities and power grid managers, where even marginal improvements in generation scheduling efficiency can yield cost-savings measured in millions of dollars and more reliable control of power system operations.

The UC problem in power systems planning involves determining the optimal schedule for turning power generating units on or off over a given time horizon in such a way that the total operating cost is minimized while reliably meeting electricity demand at each time interval. This problem is inherently a MIP due to the combination of binary and continuous decision variables. For each generating unit jϵ{0, 1, . . . , N−1} and each time period tϵ{0, 1, . . . , T−1}, the binary variable

$${u}_{j}^{t} ϵ \{ 0 , 1 \}$$

represents the on/off status of unit j at time t, where a value of 1 indicates that the unit is online and 0 indicates that the unit is offline. In parallel, a continuous variable

$${p}_{j}^{t}$$

defines the power output of that unit at time t, constrained to lie within the generator's operational limits—specifically, between a minimum output p_{j,min} and a maximum output p_{j,max}, but only if the unit is turned on.

The generation cost for each unit is typically modeled as a quadratic function of its power output, taking the form

$${F}_{j}^{t} ( p ) = {a}_{j}^{t} {p}^{2} + {b}_{j}^{t} p + {c}_{j}^{t} ,$$

where the coefficients

$${a}_{j}^{t} , {b}_{j}^{t} , and {c}_{j}^{t}$$

capture the cost characteristics specific to generator j at time t. The overall objective is to minimize the total generation cost summed across all generators and time periods. This is subject to a set of constraints: the total power generated at each time step must exactly match the system demand [symbol] ; the power output of each unit must respect its lower and upper bounds, which are active only when the unit is online; and all decision variables must reside in their appropriate domains (binary for

$${u}_{j}^{t} ,$$

real for

$${p}_{j}^{t} ) .$$

Mathematically, the UC program may be written as:

$${minimize}_{u , p} {\sum }_{t = 0}^{T - 1} {\sum }_{j = 0}^{N - 1} {u}_{j}^{t} {F}_{j}^{t} ( {p}_{j}^{t} ) ,$$

$$subject to {\sum }_{j} {p}_{j}^{t} = {ℓ}^{t} , for t = 0 , … , T - 1 ,$$

$${u}_{j}^{t} \cdot {p}_{j , min} \leq {p}_{j}^{t} \leq {u}_{j}^{t} \cdot {p}_{j , max} , for j = 0 , … , N - 1 , t = 0 , … , T - 1$$

$${u}_{j}^{t} ∈ \{ 0 , 1 \} , {p}_{j}^{t} ∈ ℝ .$$

An important structural property of the MIP is that it is separable across time periods—meaning that the optimization problem for each hour can be solved independently of the others (e.g., one time period at a time). In other words, for each t=1, . . . , T, the present disclosure solves

$$minimize {\sum }_{j = 0}^{N - 1} {u}_{j}^{t} {F}_{j}^{t} ( {p}_{j}^{t} ) ,$$

$$subject to {\sum }_{j} {p}_{j}^{t} = {ℓ}^{t} ,$$

$${u}_{j}^{t} \cdot {p}_{j , min} \leq {p}_{j}^{t} \leq {u}_{j}^{t} \cdot {p}_{j , max} , for j = 0 , … , N - 1 ,$$

$${u}_{j}^{t} ∈ \{ 0 , 1 \} , {p}_{j}^{t} ∈ ℝ .$$

As such, for each individual time period t, the UC problem reduces to finding the best subset of units to commit and their respective output levels to meet demand at minimum cost, while adhering to all operational constraints. However, even at a single time step, the problem remains challenging due to the combinatorial nature of the UC decisions and the nonlinear cost structure.

FIG. 4 illustrates a diagram of an example of the Unit Commitment (UC) problem in accordance with aspects of this disclosure. Specifically, example 400 illustrates a simple example of the UC problem with three generating units. Unit 1 may have minimum power output (Pₘᵢₙ)=250 Mega Watts (MW), maximum power output (Pₘₐₓ)=600 MW, Cost (C₁)=510.0+7.9 P₁+0.00172 P₁² $/h; Unit 2 may have Pₘᵢₙ=200 MW, Pₘₐₓ=400 MW, C₂=310.0+7.85 P₂+0.00194 P₂² $/h; and Unit 3 may have Pₘᵢₙ=150 MW, Pₘₐₓ=500 MW, C₃=78.0+9.56 P₃+0.00694 P₃² $/h. Accordingly, the UC problem in example 400 asks what combination of units 1, 2, and 3 will produce a load of 550 MW at a minimum cost and how much should each unit in that combination generate to produce 550 MW?

Since example 400 shows a simple example of the UC problem, it is possible to systematically solve all the possible combinations of units that are on or off since the total possible combinations is 2^{N}, where N is the number of units. The first row 401 corresponds to the combination with all of the three units off where the total Pₘᵢₙ and the Pₘₐₓ of this combination is 0 since all of the units are off. The next row 403 corresponds to the combination when only unit 3 is on and units 1 and 2 are off—in this case, the Pₘᵢₙ is 150 MW and Pₘₐₓ is 500. In row 405, unit 1 is off and units 2 and 3 are on—Pₘᵢₙ is 350 MW and Pₘₐₓ is 900. This combination is feasible because the load of 550 MW is between 350 and 900 MW. Accordingly, to calculate how much each unit should produce, an economic dispatch has to be performed. Since unit 3 is more expensive than unit 2, unit 3 will produce its minimum power 150 MW while unit 2 will produce its maximum power of 400 MW. At row 407, the combination is unit 1 is on and units 2 and 3 are off—this means that Pₘᵢₙ is 250 MW and Pₘₐₓ is 600 MW so this is also another feasible combination and unit 1 will produce all of the 550 MW. Having determined the feasible combinations, the cost associated with the load supplied by the combinations can now be calculated, as shown in the last column of the table. Accordingly, it is shown that the cheapest way to produce 550 MW is to only use Unit 1 since the total cost is 5389 dollars, as shown in row 407. Thus, the solution to the UC problem is that unit 1 should be turned on and units 2 and 3 should be turned off.

Example 400 describes a simple example since there are only three units. However, it should be noted that most practical cases include many more units such that it quickly becomes impractical to solve for all combinations (e.g., 2^{N}).

The present disclosure is predicated on the insight that the solution of an hourly MIP can be reformulated as the solution of 2^{N} residual quadratic programs (QPs), each corresponding to a distinct unit commitment vector uϵ{0, 1}^{N}. As mentioned above, exact resolution of MIP could be achieved by exhaustively solving all 2^{N} residual QPs. However, due to the exponential growth in the number of unit commitment configurations with respect to N, such an exhaustive approach is computationally impractical for real-time or large-scale applications. Accordingly, the present disclosure provides a method for identifying a tractable subset of representative residual QPs which, when solved, yield an approximate solution to the original MIP with provable or empirically validated bounds on suboptimality. This selective strategy enables efficient and scalable resolution of hourly MIPs without necessitating complete enumeration of the feasible commitment space.

Specifically, the decomposition methodology described in the present disclosure is based on the principle that solving a UC MIP with N generators is equivalent to solving 2^{N} real quadratic programs. For example, the following equality is presented:

$${min}_{u , p} \{ {\sum }_{j = 0}^{N - 1} {u}_{j} {F}_{j} ( {p}_{j} ) \vert {u}^{T} p = ℓ , {u}_{j} {p}_{j , min} \leq {p}_{j} \leq {u}_{j} {p}_{j , max} \} = {min}_{w} \{ {min}_{p} \{ {\sum }_{j = 0}^{N - 1} {w}_{j} {F}_{j} ( {p}_{j} ) \vert p ∈ Ω ( w ) \} \vert w ∈ {\{ 0 , 1 \}}^{N} \} .$$

In the last equation, Ω(u)={p|u^{T}p= [symbol] , uⱼp_{j,min}≤pⱼ≤uⱼp_{j,max}} denotes the feasible polytope corresponding to the unit commitment vector u. For simplicity of notation, the solution to each residual QP is denoted by:

$$RQP ( u ) = {min}_{p} \{ {\sum }_{j = 0}^{N - 1} {u}_{j} {F}_{j} ( {p}_{j} ) \vert p ∈ Ω ( u ) \} .$$

With this notation in hand, the equation:

$${min}_{u , p} \{ {\sum }_{j = 0}^{N - 1} {u}_{j} {F}_{j} ( {p}_{j} ) \vert {u}^{T} p = ℓ , {u}_{j} {p}_{j , min} \leq {p}_{j} \leq {u}_{j} {p}_{j , max} \} = {min}_{w} \{ RQP ( w ) \vert w ∈ {\{ 0 , 1 \}}^{N} \} .$$

In principle, each hourly MIP can be solved by solving 2^{N} real residual QPs, one for each unit commitment vector. However, as mentioned above, it is impractical to solve an exponential number of residual problems to obtain a solution to each hourly MIP. Thus, the present disclosure describes identifying a “reasonably small” subset of residual programs that can be used to produce a sufficiently accurate approximation to the global optimum. As used herein, a “solution to the MIP” refers to a feasible combination of binary and continuous decision variable values selected from the evaluated candidates as having the lowest total operating cost among those candidates, and encompasses both exact optimal solutions and approximate solutions that may differ from the global optimum by a bounded or empirically validated margin of suboptimality. Because the method evaluates a representative subset of candidate binary configurations rather than exhaustively enumerating all 2N possible configurations, the selected solution is generally an approximate solution whose quality depends on the size and composition of the evaluated candidate subset.

### Quantum-Classical Decomposition

The quantum-classical decomposition leverages two key observations. First, the cost function Fⱼ is strictly increasing, so Fⱼ(p_{j,min})≤Fⱼ(pⱼ) for every feasible pⱼ, if uⱼ=1. This implies that cₘᵢₙ(u)=Σⱼ uⱼFⱼ(p_{j,min}) is a lower bound for the cost of operating the units committed by u. Thus, u is a solution candidate if cₘᵢₙ(u)≤OPT, where OPT denotes the optimal objective value for the hourly MIP. Note that if a vector u is not a solution candidate, it cannot solve the hourly MIP since in that case OPT<cₘᵢₙ(u)≤Σⱼ uⱼFⱼ(pⱼ). In addition, it follows that assignment vectors with the lowest cₘᵢₙ values are the most likely to be solution candidates.

Second, feasible assignment vectors may be filtered by checking if u^{T}pₘₐₓ≥ [symbol] . For concreteness, a unit commitment vector u is feasible if Ω(u) is nonempty. Note that Ω(u) is nonempty if and only if u^{T}pₘₐₓ≥ [symbol] . Combined, the two observations imply that feasible assignment vectors with the lowest cₘᵢₙ values are most likely to be solution candidates.

### Quantum (Hybrid) Component

In some aspects, a variational quantum algorithm (VQA) may be used to tune the parameters of a variational quantum circuit with the goal of solving the following binary linear program (LP):

$$\begin{matrix}minimize & {c}_{min} ( u ) , \\ subject to & Ω ( u ) \neq ∅ .\end{matrix}$$

Then, the optimized quantum state is sampled to obtain a collection of feasible assignment vectors with low minimum operating costs (e.g., these have the highest chance of being solution candidates). The samples are then ranked according to their cₘᵢₙ value and keep only a fixed number of samples, which may be chosen ahead of time. This set of samples is denoted as U(θ*), where θ* denotes the optimized variational circuit parameters.

### Classical Component

After sampling the quantum circuit, each sampled feasible assignment vector is used to define a corresponding residual quadratic program (RQP), which is then solved over the continuous decision using the SLSQP algorithm, thereby generating a set of RQP(u) objective values. Thus, the best assignment may be reported as argminᵤ{RQP(u)|u∈U(θ*)}.

FIG. 5 illustrates a method for solving a mixed-integer optimization program having both binary and continuous variables in a power system in accordance with aspects of this disclosure. In general, it is noted that the exemplary method 500 can be implemented using the components and systems described herein, especially with respect to QIP system 200 and general controller 205 of FIG. 2 as described above and system 600 and computing device 602 of FIG. 6 as described below. The steps and algorithms described in relation to process 500 may be executed by processor 310 using algorithms components 210. In some implementations, the process 500 is performed by a processor executing code stored in a non-transitory computer-readable storage medium (e.g., a memory). The method 500 describes a proposed decomposition method that approximates the solution to each hourly MIP by first identifying low-cost feasible unit commitment vectors using a quantum heuristic, then solving corresponding residual quadratic programs via a optimization routine to determine optimal power levels, and finally selecting the unit commitment vector that minimizes the overall objective function. As used herein, a “constrained numerical optimization routine” refers to a classical algorithm (e.g., Sequential Least Squares Programming (SLSQP)), that solves optimization problems over continuous variables subject to equality and inequality constraints, wherein the optimization objective is to minimize total generation cost while satisfying physical operating constraints of the power system including power balance requirements (ensuring total generated power meets system demand) and generation capacity bounds (ensuring each unit's output remains within its operational limits. It is “optimized” because the routine systematically searches for the solution that yields the most favorable (e.g., lowest cost or highest efficiency) value of the objective function within the feasible region defined by those constraints.

At 501, the method 500 may include obtaining, by a classical processor, a formulation of the MIP comprising a set of binary decision variables representing on and off activation states for generation units, and a set of continuous decision variables representing operational levels associated with the generation units. For a UC problem, in this model, binary variables represent the on/off status of each generating unit, while continuous variables represent the power output levels of these units. This dual-variable structure reflects the need to meet hourly demand at minimum cost. However, the presence of binary variables makes the problem combinatorially complex—especially, as the number of generators increases.

As will be described in more detail below, the hybrid quantum-classical algorithm described in the present disclosure leverages this formulation by applying a Bender's-type decomposition: a quantum device first searches for promising binary unit commitment vectors that satisfy demand and minimize a lower-bound estimate of operating cost, while classical optimization routines then compute the optimal power outputs for each fixed commitment vector. This decomposition makes the MIP more tractable by separating the hard binary decision-making from the easier continuous optimization, allowing the strengths of both quantum and classical methods to be effectively combined in solving the MIP problem.

In some aspects, the MIP may correspond to a unit commitment (UC) problem for electrical power generation planning using the generation units. When this MIP is applied to UC in electrical power generation planning, it becomes a tool for determining the most cost-effective schedule for turning power generation units on or off over a planning horizon—typically in hourly intervals over a day or more. For example, as described in FIG. 4, each generation unit (e.g., a power plant) can be committed (turned on) or not committed (turned off) at any given time. This decision is modeled using the binary variables in the MIP. When a unit is turned on, it can generate power, and the exact amount it generates is modeled using continuous variables. The challenge lies in coordinating these decisions across all units to ensure that electricity demand is met at each time step, all while minimizing overall operational costs, which include fuel costs, startup costs, and potentially penalties or constraints related to emissions, ramping limits, and generator capabilities.

At 503, the method 500 may include determining, by a quantum processing unit (QPU), a subset of candidate binary variable assignments by executing a parameterized quantum circuit that encodes a cost metric associated with the binary decision variables. The candidate binary variable assignments may be generated based on measurement outcomes of qubit states of the quantum circuit. As used herein, “measurement outcomes” refers to the bit-strings obtained by measuring the qubit states of the quantum circuit after execution, wherein each bit-string represents a specific binary configuration of unit commitment decisions (i.e., which generators are turned on or off), and wherein the quantum processing unit generates a probability distribution over all possible binary variable assignments based on these measurement outcomes, from which candidate assignments are sampled according to their likelihood of yielding low-cost solutions.

This may be achieved using a quantum approach, where a quantum algorithm is employed to explore the solution space efficiently. As used herein, the term “quantum approach” refers broadly to any quantum or hybrid quantum-classical algorithm that leverages quantum computational resources—such as superposition, entanglement, or quantum tunneling—to explore the combinatorial solution space of binary decision variables and identify candidate solutions having favorable cost metric values. Non-limiting examples of suitable quantum approaches include variational quantum algorithms (VQAs), variational quantum imaginary time evolution (varQITE), the QAOA, quantum annealing, Grover-type search algorithms adapted for optimization, and other quantum heuristic or metaheuristic methods capable of sampling or identifying low-cost binary configurations. The quantum approach is not limited to any particular quantum algorithm, provided that the algorithm is configured to evaluate and prioritize candidate binary variable assignments based on a cost metric reflecting the contribution of those binary decision variables to the optimization objective. Specifically, the quantum circuit is designed to evaluate and prioritize candidate solutions based on a cost metric that reflects the contribution of the binary decision variables (e.g., the on/off status of generation units in a unit commitment problem) to the overall objective. By leveraging the quantum system's ability to sample from complex distributions, the method isolates promising binary configurations that are more likely to yield optimal or near-optimal outcomes in the subsequent optimization stages.

In some aspects, determining the subset of candidate binary variable assignments comprises limiting the subset to a predetermined number of candidate assignments based on a predetermined threshold applied to cost-bound values associated with the candidate binary variable assignments. For example, the subset of candidate binary variable assignments identified by the quantum algorithm may be intentionally limited to a fixed number of solutions. This selection is guided by a predetermined threshold based on cost-bound values, which serve as a filter to retain only the most promising candidates. Specifically, once the quantum system has generated a range of possible binary configurations—each representing a different combination of decision variables such as generator on/off statuses—these configurations are evaluated using a cost function. The cost function provides an estimated objective value for each candidate, reflecting how well it satisfies the optimization goals, such as minimizing total generation cost. Only those candidates whose estimated costs fall below a certain threshold or lie within a defined margin of the best-known value, are retained. This threshold-based pruning not only improves computational efficiency by reducing the number of configurations that must be processed in the next stage but also increases the likelihood that the remaining candidates include high-quality or near-optimal solutions.

In some aspects, executing the parameterized quantum circuit may include implementing a variational quantum algorithm (VQA). A VQA is a hybrid quantum-classical algorithm well-suited for near-term quantum hardware, combining the strengths of quantum state preparation with classical optimization techniques. In this method, a parameterized quantum circuit is constructed, where the parameters determine how quantum bits (qubits) are manipulated. The problem's objective function—such as minimizing the operational cost in a unit commitment scenario—is encoded as a quantum observable, and the quantum circuit is executed multiple times to estimate the expected value of this cost function based on the current parameters. A classical optimizer then updates the parameters to iteratively reduce the cost, guiding the quantum circuit toward quantum states that are more likely to represent high-quality solutions. Once optimized, the quantum state is sampled to generate a set of binary solutions corresponding to feasible and low-cost decision variable assignments. This approach enables efficient exploration of complex solution spaces without requiring an exhaustive search, making it a powerful tool for solving combinatorial problems like unit commitment.

In some aspects, executing the parameterized quantum circuit may include implementing a variational quantum imaginary time evolution (varQITE). varQITE is an advanced technique that simulates the behavior of a quantum system evolving under imaginary time dynamics. Unlike traditional VQAs, which minimize a cost function directly, varQITE mimics the natural process by which quantum systems settle into their ground state—the state of lowest energy, which often corresponds to the optimal solution of a given problem. In the varQITE method, a parameterized quantum circuit is used to represent the quantum state, and its parameters are updated iteratively by solving a system of linear equations derived from the imaginary time Schrödinger equation. This evolution tends to drive the quantum system toward low-energy (low-cost) configurations in a physically inspired manner. In the context of binary optimization problems such as unit commitment, varQITE can be adapted to guide the quantum state toward combinations of binary decision variables (e.g., on/off generator statuses) that yield minimal operational cost. By sampling from this optimized quantum state, the method 500 can extract high-quality candidate solutions that meet problem constraints.

In some aspects, the parameterized quantum circuit may include a parameterized ansatz having a shallow-depth entangling gate pattern arranged in a brickwork layout. For example, the quantum circuit used in the quantum approach may be designed as a parameterized ansatz—a specific, structured layout of quantum gates whose parameters are tuned during optimization. This ansatz can include a shallow-depth entangling gate pattern arranged in a brickwork layout, which refers to how the quantum gates are organized and connected. “Shallow-depth” means that the circuit has a limited number of layers, which is important for practical use on near-term quantum hardware, where long circuits are more prone to errors due to noise and decoherence. The “entangling gate pattern” ensures that qubits are connected and can influence one another, which is crucial for capturing complex correlations in optimization problems. The “brickwork layout” describes a specific tiling pattern of entangling gates—like alternating rows of bricks—where gates are applied between pairs of adjacent qubits in a staggered fashion. This layout helps maintain symmetry and connectivity while keeping the circuit efficient to execute. In the context of solving problems like unit commitment, this ansatz structure allows the quantum circuit to represent a rich and expressive space of potential solutions while remaining compatible with the physical limits of current quantum devices.

At 505, the method 500 may include, for each candidate binary assignment, solving, by the classical processor using a constrained numerical optimization routine, a continuous-variable subproblem to determine corresponding values for the continuous decision variables that minimize an objective cost subject to one or more physical operating constraints of the power system. Specifically, the method involves taking each candidate binary assignment—such as a specific on/off configuration of generation units—and solving a corresponding continuous-variable subproblem to determine the optimal values for the continuous decision variables. These continuous variables typically represent operational levels, such as the amount of power each active generator should produce. Given that the binary assignment is fixed, the original mixed-integer problem simplifies to a constrained continuous optimization problem, often a quadratic program. The goal is to minimize the total objective cost, such as fuel or generation cost, while satisfying relevant constraints—like meeting total electricity demand and respecting generation limits. In some aspects, this step is handled using a classical optimization routine, such as Sequential Least Squares Programming (SLSQP), which efficiently solves smooth, constrained problems over real-valued variables. By applying this routine to each feasible binary configuration obtained from the quantum step, the method determines the most cost-effective way to operate the selected units, bridging the binary and continuous parts of the overall optimization process.

In some aspects, the objective cost comprises a commitment cost corresponding to a fixed cost for turning on a generation unit and a generation cost corresponding to a variable cost based on how much power each generation unit produces.

In some aspects, the optimization routine comprises a sequential least squares programming (SLSQP) algorithm executed by the classical processor. SLSQP is a classical optimization algorithm used to solve nonlinear optimization problems with both equality and inequality constraints. It works by iteratively approximating the problem using a sequence of quadratic programming subproblems. SLSQP is particularly well-suited for problems with smooth objective functions and constraints, and it's widely used in engineering and scientific applications for optimizing continuous variables.

In some aspects, the method 500 may include generating, by the quantum processing unit, a probability distribution over the binary variable assignments based on measurement outcomes of the qubit states; and sampling a plurality of candidate assignments based on the probability distribution. Specifically, the method may involve generating a probability distribution over all possible binary variable assignments—each representing a potential combination of decisions, such as which generators are turned on or off. This distribution reflects the likelihood that each assignment leads to a low-cost or high-quality solution, based on prior evaluations or the structure of the quantum state (as in variational quantum algorithms). Once this distribution is formed, the method 500 samples from it to produce a set of candidate binary assignments. As used herein, “candidate binary assignments” or “candidate binary variable assignments” refers to unit commitment vectors—each representing a specific on/off configuration for the set of generation units—that are identified by the quantum algorithm as satisfying the power demand constraint and being associated with low estimated minimum operating costs, and which are subsequently evaluated by the classical optimization routine to determine their corresponding optimal power dispatch levels. By doing so, it focuses computational effort on the most promising regions of the solution space, increasing the chances of finding near-optimal solutions without exhaustively evaluating all possibilities.

At 507, the method 500 may include evaluating, by the classical processor, a total cost for each combination of the candidate binary assignments and corresponding continuous-variable solution. The total cost may correspond to an aggregate operating cost associated with a specific combination of binary and continuous decision variables. Specifically, the method 500 involves evaluating the total cost for each candidate solution by combining the binary assignment (e.g., which generators are turned on or off) with its corresponding continuous-variable solution (e.g., how much power each active generator produces). As used herein, a “continuous-variable solution” refers to the set of optimal power output values determined for each generation unit that has been committed (turned on) by a given binary assignment, wherein these real-valued power levels are computed to minimize total operating cost while satisfying the power demand and respecting each unit's minimum and maximum generation capacity constraints. For each pair, the total cost is computed by plugging the continuous values into the cost function, considering only the generators that are active according to the binary assignment. This step ensures that each full solution—consisting of a discrete configuration and its optimal operational levels—is assessed based on how well it meets the objective, such as minimizing total generation cost while satisfying constraints.

In some aspects, the total cost is computed as a sum of generation costs over a plurality of generation units and time periods, each generation cost being a quadratic function of a power output variable and included in the sum only if the corresponding generation unit is active.

At 509, the method 500 may include selecting, by the classical processor, a combination of binary and continuous decision variable values that yields a solution to the MIP. In other words, the method 500 selects the combination of binary and continuous variable values that result in the lowest total operating cost among all the evaluated candidates. Each candidate represents a full solution to the original MIP, consisting of a specific on/off configuration for generation units (binary variables) and the corresponding optimal power levels for those units (continuous variables). After computing the total cost for each of these combinations in earlier steps, the method simply compares them and chooses the one with the minimum overall cost. This selected combination is then reported as the solution to the MIP. As described above, because the method 500 evaluates a representative subset of candidate binary configurations rather than all possible configurations, the selected solution constitutes an approximate solution to the MIP that effectively balances both decision types to achieve the most cost-efficient outcome among the evaluated candidates. In various implementations, the approximation quality of this solution has been empirically validated to be within a small margin of the globally optimal solution obtained by exhaustive classical solvers.

In some aspects, selecting the combination of binary and continuous decision variable values may include selecting a combination corresponding to a lowest total cost among the subset of candidate binary variable assignments.

At 511, the method 500 may include outputting control signals for at least one generation unit based on the selected combination of binary and continuous decision variable values to control operation of the power system. As used herein, “control signals” broadly refer to electronic instructions, commands, or data outputs that direct the operational state of one or more generation units within a power system. These signals may take various forms depending on the system architecture, including digital dispatch commands, setpoints specifying target power output levels, and commitment signals such as start-up or shut-down instructions. In implementations using systems such as Supervisory Control and Data Acquisition (SCADA) or an energy management system (EMS), control signals may be transmitted over communication networks (e.g., IEC 61850, DNP3, or Modbus) as digital messages, encoded data packets, or analog references to local controllers, Programmable Logic Controller (PLCs), or Distributed Control System (DCSs). A computing device receives optimized decision variable values, converts them into compatible control formats, and transmits them via wired or wireless links either directly to generation units or through intermediary controllers. These signals cause generation units to adjust their operating states—for example, activating and ramping to a specified output when assigned an “on” value, or shutting down when assigned an “off” value—thereby implementing the optimized unit commitment and dispatch solution and effecting a physical change in the power system.

In this way, the proposed Benders-type decomposition for the UC problem offers a highly efficient alternative to iterative QAOA-based approaches by invoking the quantum device only once to generate a ranked collection of candidate commitment vectors. This “one-shot” approach significantly reduces the quantum computational burden and circuit executions, making it ideal for resource-constrained NISQ hardware. By cleanly separating the combinatorial binary optimization (quantum) from the continuous power dispatch (classical), the method ensures each task is handled by its most effective paradigm. This modular architecture allows for independent hardware or algorithmic upgrades and enables parallel processing of hourly subproblems to improve throughput.

It is understood that the method illustrated by FIG. 5 is exemplary in nature and that the steps described herein may be combined or modified to generate alternative embodiments.

FIG. 6 illustrates an example of a QIP system in accordance with aspects of this disclosure. The example QIP system 600 shown in FIG. 6 includes a control subsystem 610 that can receive a quantum program 604 from a computing device 602 that is remotely located relative to the example QIP system 600 and is functionally coupled (e.g., communicatively coupled) to the control subsystem 610. The computing device 602 can send data defining the quantum program 604 to control subsystem 610 for execution in quantum hardware 620, determining qubit placement in the quantum circuit, as described herein. As is indicated by dashed lines, the computing device 602 can be external to the example QIP system 600. For example, the computing device 602 can be a user device (e.g., a classical computer) of an end-user of the QIP system 600. The control subsystem 610 can retain the quantum program 604 in one or more memory devices 612. The quantum program 604 corresponds to a defined quantum computation. The defined quantum computation can be an n-qubit computation, for example. The quantum program 604 can include a quantum circuit (and, in some cases, sub-circuits, such as the state preparation component, cost (objective) encoding component, mixer (exploration) component, and measurement component) representing a quantum algorithm associated with the quantum computation. Examples of the quantum algorithm include a variational quantum algorithm, a machine-learning algorithm, a Fourier transform algorithm, or the like.

The control subsystem 610 can be functionally coupled to quantum hardware 620 via multiple links 614 that permits the exchange of data and/or control signals between the control subsystem 610 and the quantum hardware 620. The quantum hardware 620 can embody or can include one or more quantum computers. In some cases, the quantum hardware 620 embodies a cloud-based quantum computer. In other cases, the quantum hardware 620 embodies, or includes a local quantum computer. Regardless of its spatial footprint, the quantum hardware 620 includes multiple qubits 630 arranged in a particular layout. Each qubit of the qubits 630 (including the target and ancilla qubits described herein) can be coupled to an environment and/or to one another. Such coupling(s) decoheres and relaxes quantum information contained in the qubit. Thus, the quantum hardware 620 can be noisy. The type of the multiple links can be based on the type of qubits 630 used by the quantum hardware 620 for computation. In some cases, the multiple links 614 can include wireline links or optical links, or a combination of both. In other cases, the multiple links 614 can include microwave resonator devices or microwave transmission lines, or a combination of both.

The qubits 630 can include atomic qubits assembled in an atom-trap. Thus, the atomic qubits can be referred to as trapped-atom qubits. In some cases, each one of the atomic qubits can be a neutral atom. In other cases, each one of the atomic qubits can be an ion, such as an Ytterbium ion, a calcium ion, or similar ions. The atomic-qubits in such cases can be confined within an ion-trap (e.g., the trap 270 (FIG. 2) and can be assembled in a linear arrangement (such as the linear crystal or chain 110 (FIG. 1)). In other implementations, the qubits 630 can include solid-state devices of one of several types. Such devices can be embodied in, for example, Josephson junction devices, semiconductor quantum-dots, or defects in a semiconductor material (such as vacancies in Si and Ge, or nitrogen-vacancy centers in diamond).

The control subsystem 610 can cause the quantum hardware 620 to execute the quantum circuit and/or sub-circuits as described herein. In response, the control subsystem 610 can receive measurement data 618 indicative of computation outputs that includes the output of the combination of binary and continuous variable values (e.g., solution to the MIP), for example. Because the quantum computation can be performed in two or more qubits, a measurement outcome can be represented as a bitstring representing a particular target output state given a particular set of qubits involved in a quantum computation. The control subsystem 610 can supply at least a portion of the measurement data 618 to components of the control subsystem 610 and/or other subsystems (e.g., post-processing subsystem 650).

The control subsystem 610 also can be functionally coupled to a post-processing subsystem 650 via a communication architecture 640. The communication architecture 640 can include wirelines links, wireless links, network devices (such as gateway devices, servers, and the like), or a combination thereof. The post-processing subsystem 650 can apply one or several post-processing techniques to measurement data 618 received from the quantum hardware 620. By applying such techniques, the post-processing subsystem 650 can generate a result 654 of a quantum computation executed by the quantum hardware. The post-processing subsystem 650 can send the result 654 (or data indicative of the result 654) to the computing device 602 and/or other computing device(s) 658. The post-processing subsystem 650 also can cause the computing device 602 to present the result 654 in a particular way. For example, the post-processing subsystem 650 can direct the computing device 602 to present a user interface including the result 654.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

In general, it is noted that the foregoing description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for solving a mixed-integer optimization program for controlling operation of a power system, the method comprising:
obtaining, by a classical processor, a formulation of the mixed-integer program (MIP) comprising a set of binary decision variables representing on and off activation states for generation units, and a set of continuous decision variables representing operational levels associated with the generation units;
determining, by a quantum processing unit (QPU), a subset of candidate binary variable assignments by executing a parameterized quantum circuit that encodes a cost metric associated with the binary decision variables, wherein the candidate binary variable assignments are generated based on measurement outcomes of qubit states of the quantum circuit;
for each candidate binary assignment, solving, by the classical processor using a constrained numerical optimization routine, a continuous-variable subproblem to determine corresponding values for the continuous decision variables that minimize an objective cost subject to one or more physical operating constraints of the power system;
evaluating, by the classical processor, a total cost for each combination of the candidate binary assignments and corresponding continuous-variable solution, wherein the total cost corresponds to an aggregate operating cost associated with a specific combination of binary and continuous decision variables;
selecting, by the classical processor, a combination of binary and continuous decision variable values that yields a solution to the MIP; and
outputting control signals for at least one generation unit based on the selected combination of binary and continuous decision variable values to control operation of the power system.

2. The method of claim 1, wherein executing the parameterized quantum circuit comprises implementing a variational quantum algorithm (VQA).

3. The method of claim 1, wherein executing the parameterized quantum circuit comprises implementing a variational quantum imaginary time evolution (varQITE).

4. The method of claim 1, wherein the optimization routine comprises a sequential least squares programming (SLSQP) algorithm executed by the classical processor.

5. The method of claim 1, further comprising:
generating, by the quantum processing unit, a probability distribution over the binary variable assignments based on measurement outcomes of the qubit states; and
sampling a plurality of candidate assignments based on the probability distribution.

6. The method of claim 1, wherein the MIP corresponds to a unit commitment (UC) problem for electrical power generation planning using the generation units.

7. The method of claim 1, wherein the parameterized quantum circuit comprises a parameterized ansatz having a shallow-depth entangling gate pattern arranged in a brickwork layout.

8. The method of claim 1, wherein determining the subset of candidate binary variable assignments comprises limiting the subset to a predetermined number of candidate assignments based on a predetermined threshold applied to cost-bound values associated with the candidate binary variable assignments.

9. The method of claim 1, wherein the objective cost comprises a commitment cost corresponding to a fixed cost for turning on a generation unit and a generation cost corresponds to a variable cost based on how much power each generation unit produces.

10. The method of claim 9, wherein the total cost is computed as a sum of generation costs over a plurality of generation units and time periods, each generation cost being a quadratic function of a power output variable and included in the sum only if the corresponding generation unit is active.

11. The method of claim 1, wherein selecting the combination of binary and continuous decision variable values comprises selecting a combination corresponding to a lowest total cost among the subset of candidate binary variable assignments.

12. A hybrid quantum-classical optimization system for controlling operation of a power system, the system comprising:
a classical computing system comprising one or more processors and memory storing instructions that, when executed, cause the classical computing system to:
obtain a formulation of a mixed-integer optimization program (MIP) comprising: (i) a set of binary decision variables representing on and off activation states for generation units, and (ii) a set of continuous decision variables representing operational levels associated with the generation units;
for each candidate binary variable assignment, solve a continuous-variable subproblem using an optimization routine to determine corresponding values for the continuous decision variables that minimize an objective cost subject to one or more physical operating constraints of the power system;
evaluate a total cost for each combination of candidate binary variable assignments and corresponding continuous-variable solutions; and
select a combination of binary and continuous decision variable values based on the evaluated total cost; and
a quantum processing unit (QPU) communicatively coupled to the classical computing system and configured to:
receive data representing at least the binary decision variables and an associated cost metric of the MIP;
encode the binary decision variables and the associated cost metric into a parameterized quantum circuit;
execute the parameterized quantum circuit using a sequence of quantum gate operations; and
generate a subset of candidate binary variable assignments based on measurement outcomes of qubit states resulting from execution of the parameterized quantum circuit;
an interface configured to transmit the subset of candidate binary variable assignments from the QPU to the classical computing system; and
a control module configured to generate control signals for at least one generation unit of the power system based on the selected combination of binary and continuous decision variable values to control operation of the power system,
wherein the hybrid quantum-classical optimization system is configured to reduce computational complexity of solving the mixed-integer optimization program relative to a classical-only optimization system.

13. The system of claim 12, wherein the quantum processing unit (QPU) is configured to execute the parameterized quantum circuit using a variational quantum algorithm (VQA) to generate the subset of candidate binary variable assignments.

14. The system of claim 12, wherein the QPU is configured to execute the parameterized quantum circuit using a variational quantum imaginary time evolution (varQITE) process to generate the subset of candidate binary variable assignments.

15. The system of claim 12, wherein the optimization routine executed by the classical computing system comprises a sequential least squares programming (SLSQP) algorithm.

16. The system of claim 12, wherein the QPU is further configured to:
generate a probability distribution over the binary variable assignments based on measurement outcomes of the qubit states resulting from execution of the parameterized quantum circuit; and
sample a plurality of candidate binary variable assignments from the probability distribution for transmission to the classical computing system.

17. The system of claim 12, wherein the MIP corresponds to a unit commitment (UC) problem for electrical power generation planning using the generation units.

18. The system of claim 12, wherein the parameterized quantum circuit is a parameterized ansatz having a shallow-depth entangling gate pattern arranged in a brickwork layout.

19. The system of claim 12, wherein the QPU is configured to limit the subset of candidate binary variable assignments to a predetermined number of candidate assignments selected based on a threshold applied to cost-bound values associated with the candidate binary variable assignments.

20. The system of claim 12, wherein the objective cost comprises a commitment cost corresponding to a fixed cost for activating a generation unit and a generation cost corresponds to a variable cost based on a power output level of each generation unit.
